(19) United States
(12) Patent Application Publication
(10) Pub. No.: US 2008/0309123 A1
(43) Pub. Date: Dec. 18, 2008

(54) Reinforcement and armouring panel for a vehicle

(75) Inventors: Alvaro Paluffi, Santo Stefano Magra (IT); Paolo Mariotti, Massa (IT)

Correspondence Address: HEDMAN & COSTIGAN P.C., 1185 AVENUE OF THE AMERICAS, NEW YORK, NY, 10036, US

(73) Assignee: OTO MELARA S.p.A., La Spezia (IT)

(21) Appl. No.: 12/156,028

(22) Filed: May 29, 2008

(30) Foreign Application Priority Data
Jun. 14, 2007 (IT) MI2007A 001200

(51) Int. Cl. B62D 39/00

(52) U.S. Cl. 296/187.03

(57) ABSTRACT

Reinforcement and armouring panel for a vehicle, comprising a pair of metal sheets (3) provided between which is a layer (4) made of sacrificial material made of metal or ceramic foam.

### The present invention refers to a reinforcement and armouring panel for a vehicle.

In particular, the present invention refers to a reinforcement and armouring panel for a vehicle, of the type made of a multilayer panel provided with layers of material which deforms plastically (sacrificial layers) without damaging the main structure.

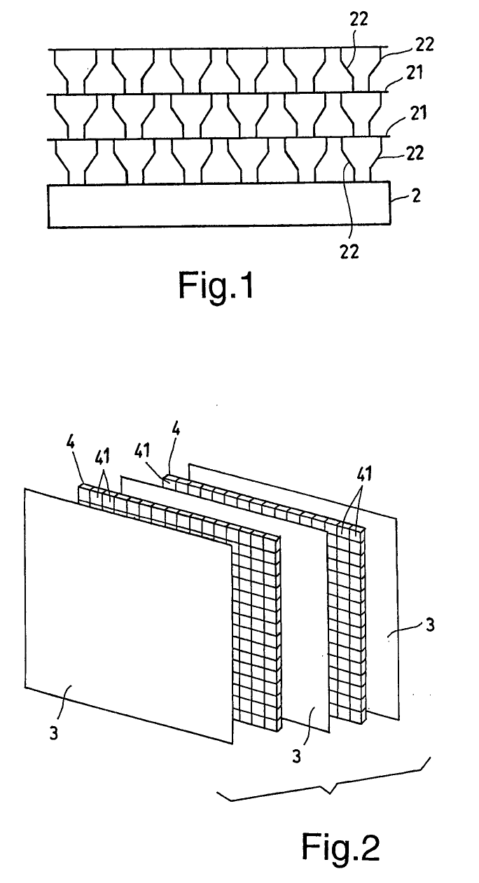

It is known that materials, having perfectly plastic characteristics, can be layers made up of adjacent and overlapped metal cells and metal or ceramic foams. FIG. 1 shows an example of a reinforcement and armouring panel formed by a non-sacrificial structure 2 and by a plurality of sacrificial layers each formed by a base sheet 21 provided on which are variously shaped lamellas 22 (for example forming a honeycomb structure), which connect it to the base sheet of the subsequent layer forming the abovementioned cells.

The applicant thought of providing a reinforcement and armouring panel for a vehicle using ceramic or metal foams.

For such purpose, the applicant made a reinforcement and armouring panel, for a vehicle, formed by a plurality of aluminium sheets separated by at least one layer of ceramic foam, made up of cubes of such material composed in a mosaic in such a manner to form such layer. Furthermore, the applicant prepared a procedure for manufacturing such reinforcement panels.

An aspect of the present invention refers to a reinforcement and armouring panel for a vehicle, with the characteristics of the attached claim 1.

Further characteristics of the panel are included in the subsequent dependent claims.

A further aspect of the present invention refers to a procedure for manufacturing such panel with the characteristics of the attached claim 8.

Further objectives and advantages of the present invention shall be clearer from the following description and annexed drawings, strictly provided for exemplifying and non-limiting purposes, wherein:

FIG. 1 schematically represents an exploded view of a multilayer panel provided with a honeycomb structure;

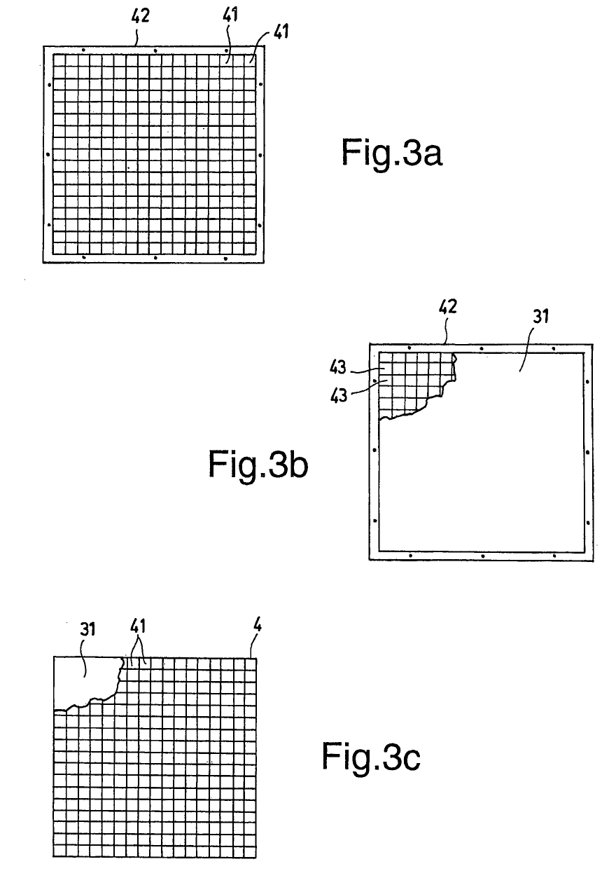

FIG. 2 schematically represents an exploded view of a multilayer panel according to the present invention;

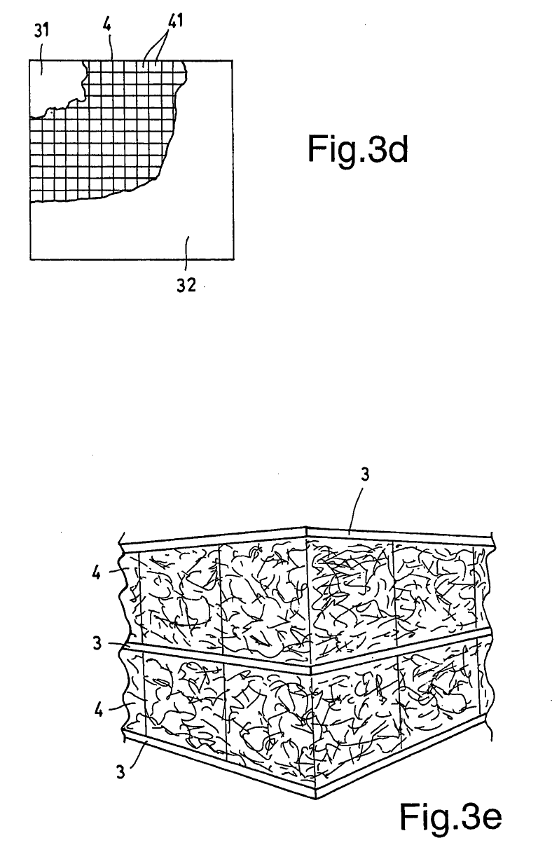

FIGS. 3a-3e illustrate the various steps of the procedure for manufacturing the panel according to the present invention.

Referring to the mentioned figures the panel according to the present invention can be used as a reinforcement and armouring panel for vehicles and arranged for example on the following zones:
Sides
Hull-bottom.

Such panel comprises a plurality of metal sheets 3, for example made of aluminium, placed between which is a metal or ceramic foam layer 4. Preferably, the foam layer comprises a plurality of foam elements, for example cubes 41, arranged in a manner to form a substantially smooth surface, inserted between two adjacent metal sheets.

Metal foams suitable for the present invention are open-celled foams having pores between 1 and 4 mm, based on alumina (Al2O3).

Ceramic foams suitable for the present invention are open-celled foams based on silicon carbide (SiC) with pores from 2 to 4 mm.

A suitable thickness of the aluminium sheets amounts to approximately 1-5 mm while the thickness of the foam layer amounts to approximately 30-50 mm.

The procedure for manufacturing such panel (illustrated in FIGS. 3a-3e) provides for the use of ceramic foams in regular-shaped elements 41, preferably of the same dimensions, in such a manner to be attachable to each other to form a substantially smooth layer. A shape suitable for such objective is for example a parallelepiped or cube shape.

In the first step, the elements 41 are arranged side by side inside a special frame or mould 42 of preset shape and dimensions, in such a manner to form a substantially smooth foam layer 4 of the desired dimensions (FIG. 3a).

Subsequently, on a surface of the first metal sheet 31 made of the same the dimensions of the foam layer, a resin (for example a protomix resin) is spread and such surface is laid over the foam layer (FIG. 3b) sticking the metal sheet to the foam layer hence obtaining a first manufactured product.

Subsequently, the sheet plus foam layer assembly is overturned and the mould is removed (FIG. 3c).

Then a surface of a second metal sheet is smeared with the abovementioned resin and the sheet is placed on the manufactured product on the side smeared with resin sticking it thereto (FIG. 3d). Subsequently, also the upper uncovered side of such second metal sheet is smeared with such resin and another manufactured product is placed over it, subjecting the obtained panel to pressure for a preset period of time to let the resin dry. Finally obtained, as illustrated in FIG. 3e, is a panel made up of three sheets and two foam layers. Panels having additional foam layers and additional metal sheets can be obtained by sticking, using resin, additional manufactured products (a sheet+a foam layer) on an already made panel.

1. Reinforcement and armouring panel for a vehicle comprising at least one pair of metal sheets (3) provided between which is at least a one layer (4) made of sacrificial material characterised in that such at least one layer made of sacrificial material is made of metal or ceramic foam and such pair of sheets is made of aluminium.

2. Panel according to claim 1, wherein such foam is open-celled foam.

3. Panel according to claim 1, wherein such metal foam is an alumina based open-celled foam.

4. Panel according to claim 1, wherein such ceramic foam is a silicon carbide based open-celled foam.

5. Panel according to claim 1, wherein the thickness of the aluminium metal sheets amounts to approximately 1-5 mm, while the thickness of the foam layer amounts to approximately 30-50 mm.

6. Panel according to claim 1, wherein such foam layer (4) is made up of a plurality of regular-shaped elements (41), arranged side by side in a manner to form a substantially smooth layer.

7. Panel according to claim 1, wherein such elements are parallelepiped or cube shaped.

8. Procedure for manufacturing reinforced and armouring panels for a vehicle characterised in that it comprises the following steps:
a) Aligning inside a mould (42) of preset shape and dimensions a plurality of regular-shaped foam elements (41) in such a manner to form a substantially smooth foam layer (4),
b) On a surface of a first metal sheet (31) spreading a resin and laying such surface over the foam layer obtaining a first manufactured product,
c) Overturning such first manufactured product and removing the mould,
d) Smearing a surface of a second metal sheet (32) with the mentioned resin
e) Placing such second sheet on such first manufactured product on the side smeared with resin sticking it thereto
f) Smearing the uncovered upper side of such second metal sheet with such resin,
g) Placing on such uncovered upper side an additional manufactured product made according to steps a-f
h) Subjecting the panel obtained to pressure for a preset period of time to let the resin dry.

9. Procedure according to claim 8, comprising the further step of placing additional manufactured products on an already formed panel according to steps a-h.
